(19) United States
(12) Patent Application Publication
(10) Pub. No.: US 2022/0009364 A1
(43) Pub. Date: Jan. 13, 2022

(54) CONTACT UNIT AND CHARGING SYSTEM

(71) Applicant: SCHUNK TRANSIT SYSTEMS GMBH, Wettenberg (DE)

(72) Inventors: Bjoern Weisshar, Oberkleen (DE); Thomas Hengstermann, Rheine (DE); Lothar Schneider, Lahnau (DE)

(21) Appl. No.: 17/294,728

(22) PCT Filed: Nov. 5, 2019
(86) PCT No.: PCT/EP2019/080278

§ 371 Date: May 18, 2021

(30) Foreign Application Priority Data
Nov. 22, 2018 (DE) 10 2018 129 430.1

(51) Int. Cl. B60L 53/16; B60L 53/14; H02J 7/00; H01R 13/22; H01R 13/03

(52) U.S. Cl. CPC B60L 53/16; B60L 53/14; H01R 2201/26; H01R 13/22; H01R 13/03; H02J 7/0042

(57) ABSTRACT

The invention relates to a contact unit (16) for a charging system for electrically driven vehicles, in particular passenger vehicles, trucks, busses or the like, and a charging system, the charging system comprising a charging contact device and a contact device having a contact unit carrier, the contact unit carrier having the contact unit, the contact unit being electrically connectable to a charging contact of the charging contact device to form a contact pair, the contact unit having a contact element (19) made of metal, the contact unit having a connecting lead (20) for connection to the vehicle or the charging station, the contact element having a contact bump (21), the contact bump forming a contact surface (22) for forming an electric contact with the charging contact, the contact element being at least partially formed by a contact piece (23) in the area der contact surface.

The invention relates to a contact unit for a charging system for electrically driven vehicles, in particular passenger vehicles, trucks, busses or the like, and a charging system, the charging system comprising a charging contact device and a contact device having a contact unit carrier, the contact unit carrier having the contact unit, the contact unit being electrically connectable to a charging contact of the charging contact device to form a contact pair, the contact unit having a contact element made of metal, the contact unit having a connecting lead for connection to the vehicle or the charging station, the contact element having a contact bump, the contact bump forming a contact surface for forming an electric contact with the charging contact.

Contact units and charging systems of this kind are known from the state of the art and are typically employed for charging electrically driven vehicles at a stop, for instance. A distinction is made between charging systems which are disposed on a vehicle roof or below a vehicle floor. From WO 2015/018889 A1, a charging system is known in which a contact unit carrier of a contact device which matches the charging contact device (in shape) is electrically connected with a roof-shaped charging contact device. The contact unit carrier is guided into a contact position, contact elements in the contact unit carrier sliding along roof-shaped inclines of the charging contact device and the contact unit carrier becoming centered in the charging contact device. The contact device and the charging contact device are joined by means of a positioning device which is disposed on the vehicle roof in the manner of a rocker. Batteries of the vehicle can be charged during a stop of the vehicle at a stationary charging station. Contact pairs are then formed for a charging circuit and for a control line, grounding or data transmission, for instance. It is therefore always envisaged that a plurality of contact elements are each electrically connected with an assigned charging contact.

On some types of vehicles, cars for instance, the charging system is disposed below a vehicle for practical and aesthetical reasons. It is also possible to use this position for trucks or busses. Charging systems known from the state of the art which are realized for transmitting high currents, such as 500 A to 1,000 A at a voltage of 750 V, always require contacts units or contact elements to have correspondingly large dimensions and corresponding conductor cross sections.

A general problem for forming a contact pair are contamination on the contact elements or charging contacts and an oxidation or corrosion of a surface of the contact elements or charging contacts. The contact elements or charging contacts commonly consist of copper or a copper alloy in order to be able to transfer currents which are as high as possible, in which case an oxidation layer is generated relatively quickly. If the contact elements drag along surfaces of a charging contact device when they are inserted into a contact position, contamination and an oxidation layer can be removed from the contact elements or charging contact elements if applicable. Furthermore, these kinds of contaminations on contact pairs are not of great importance for a charging circuit at a voltage of 750 V, for example, since contaminations and oxidation layers can easily be bridged and also be removed, if necessary, because of the high voltage and a heat development during charging. However, this is not the case with contact pairs for a control line, grounding or data transfer, which is why undesired contact disruptions can occur if a contamination or oxidation layer is not removed by abrasion. Because of the low voltage used with these contact pairs, these contact pairs are more sensitive to corrosion problems, such that a safe signal transmission or grounding, for example, cannot always be guaranteed.

Therefore, the object of the present invention is to propose a contact unit and a charging system which both ensure a reliable contact quality.

This object is attained by a contact unit having the features of claim 1 and a charging system having the features of claim 16.

In the contact unit according to the invention for a charging system for electrically driven vehicles, in particular passenger vehicles, trucks, busses or the like, the charging system comprises a charging contact device and a contact device having a contact unit carrier, the contact unit carrier having the contact unit, the contact unit being electrically connectable to a charging contact of the charging contact device to form a contact pair, the contact unit having a contact element made of metal, the contact unit having a connecting lead for connection to the vehicle or the charging station, the contact element having a contact bump, the contact bump forming a contact surface for forming an electric contact with the charging contact, the contact element being at least partially formed by a carbon contact piece in the area of the contact surface.

Thus, the contact element is formed having a contact bump, which for its part forms the contact surface for forming an electric contact with a charging contact. The contact bump can generally have any shape and be formed such that the contact element has a chamfer or a curvature on its outer edges. The point or the surface of the contact bump closest to or facing the charging contact, is part of the contact surface. This contact surface is at least partially formed by a carbon contact piece. Since the contact element is made of metal, the contact piece is disposed on or attached to the contact element accordingly. In this case, the contact piece can also form the entire contact surface. Since the contact surface is at least partially formed by the contact piece, the contact surface cannot oxidize in these areas because of the carbon which forms the contact surface. Carbon is suitable as an electrically conductive material for forming the contact surface because, in particular in the case of contact pairs, no high currents have to be transferred for transmitting signals. Furthermore, carbon is environmentally compatible, robust and has good sliding properties. Since a contact piece is used, an abrasion of carbon resulting from a longer lasting use will not interfere with a signal transmission. Furthermore, the contact unit can be produced inexpensively, since contact pieces made of carbon can easily be produced and installed on the contact element.

The contact element can be realized so as to be bolt-shaped and/or the contact surface can be realized so as to be at least partly curved, preferably dome-shaped. The bolt-shaped contact bump can form the contact surface for forming an electric contact with the charging contact, a distal end of the contact element being formable so as to be rounded, curved or dome-shaped. It can thus be ensured that, even in the case of a different position relative to the charging contact, the contact element constantly abuts on the charging contact by means of a selective contact. In this case, the contact element can also be moved along a charging contact without the charging contact or the contact element sustaining any major mechanical damage. Alternatively, the contact element can have any other suitable shape. If the bolt-shaped contact element is disposed so as to be moveable or pivotable on a contact unit carrier in the direction of its longitudinal axis, a large-scale contact with a charging contact can be formed, if necessary, because of a complete curvature or rounded edges on a contact end of the contact element.

The contact piece can be realized so as to be flush with the contact surface. For example, the contact piece can be formed so as to be flush with the contact surface after an assembly of a contact element by means of mechanical processing, such as milling, rotating or sanding the contact element. In this case, the contact surface does not have any recesses or protrusions. Furthermore, the contact element can be made of copper or a copper alloy and be flat or uncoated. In this case, the contact surface is at least partially made of carbon and copper or is made of these materials. Generally, it is also possible, however, to coat the metal of the contact element. For example, the metal of the contact element can be coated with silver, although silver is relatively costly and sensitive to mechanical forces.

The contact piece can be made of graphite or hard coal. Industrially manufactured graphite or hard coal is inexpensively available; in this case admixtures of metal, such as copper or silver, may also be contained in the graphite or the hard coal. Graphite or hard coal are corrosion-resistant, wear-resistant and robust.

The contact piece can be coaxially disposed relative to a longitudinal axis of the contact elements, the contact piece being able to form a point of the contact surface closest to the charging contact. The contact piece can thus be positioned in the center of the contact surface with respect to an outer contour of the contact surface, in particular if the contact surface is also formed by the contact element. The contact piece can then also form the highest point of the contact surface, for example, such that when guiding the contact element and the charging contact together, the contact piece directly comes into contact with the charging contact. Thus, a safe electric contact can advantageously be formed.

A first partial surface of the contact surface can be formed by the contact piece and a second partial surface of the contact surface can be formed by the contact bump, the first partial surface being circular, rectangular, square, star-shaped or cross-shaped. The first partial surface can also accordingly be disposed relatively transversely to a longitudinal axis of the contact piece. The second partial surface can surround the first partial surface or also be interspersed by said first partial surface. For example, when the first partial surface is formed so as to be square, the first partial surface can be formed in the manner of a strip which extends through the first partial surface.

The contact piece can be inserted into a cavity which is formed in the contact bump. The cavity can be, for example, a bore or a groove extending transversely to the longitudinal axis of the contact element. In this case, the contact piece essentially fully fills out the cavity. In principle, it is also possible to attach the contact piece in the cavity in a form-fitting or force-fitting manner. A simple form-fitting attachment can be realized by means of a pin connection.

The contact piece can be attached in the cavity by means of an electrically conductive bonding material or a solder. In this case, the contact piece can be soldered or glued into the cavity. This ensures in any case that a good electrically conductive connection is formed between the contact piece and the metal of the contact element at all times.

Alternatively, the contact piece can be formed in the cavity by means of sintering. In this case, the contact piece can be formed directly in the cavity and thus be deeply anchored within it. Forming the contact piece by means of sintering can be realized in a piece of raw material of the contact element, a mechanical processing of the thus formed semi-finished product being able to be carried out subsequently.

A spring of the contact unit can exert a spring force on the contact element, such that the contact element can be pushed in the direction of a charging contact. The contact element can be elastically mounted using a compression spring, in particular a coil spring, on the contact element or in the area of a pivot bearing or a guide of the contact unit. As a result, a point contact with a charging contact can be established under spring pre-load. A spring force can be selected such that the contact element is at all times pushed toward the charging contact and into a front end position when the contact element is not in contact with a charging contact. The spring can also be a coiled torsion spring which can be mounted on an axis of a pivot bearing of the contact element. For example the contact element can thus be pivoted into an end position on a pivot bearing by means of a spring force.

The contact device can have at least two additional contact units, the respective contact surface for forming an electric contact with the charging contact being completely made of metal. The metal of the contact surface of the additional contact elements of the additional contact units can be copper or a copper alloy, for example. Furthermore, the additional contact elements can have a coating, for example a silver coating. The two additional contact elements can then form charging contacts of a charging circuit, via which comparatively high voltages and currents can be transferred. In this case, using a contact piece made of carbon is not necessary for the additional contact elements.

The contact unit can be realized such that a signal can be transmitted via the contact element, a current of 100 A to 1,000 A, preferably of 500 A to 1,000 A, particularly preferably of 800 A, at a voltage of 60 V to 1,500 V, preferably of 750 V, being transferrable via the additional contact units. Consequently, a performance of 375 kW to 750 kW, preferably of 600 kW, can be transmitted via the additional contact units. Also, a vehicle can be charged quicker because higher currents can be transmitted in less time. If applicable, a number of the contact units on the contact unit carrier may also be reduced, making production of a contact device more cost-effective.

The connecting lead can be directly or indirectly attached to the contact element. In contrast to contact elements having a contact element guide as known from the state of the art, it is no longer necessary to utilize a gap between the contact element guide and the contact element for transferring currents in the case of a direct arrangement. In this case, the connecting lead can also be moved together with the contact element. Furthermore, sliding greases or other components for facilitating current transferal in the area of a contact element guide or a pivot bearing are no longer necessary. A transition resistance between the connecting lead and the contact element can thus be decreased substantially. The connecting lead can have a conductor cross section of at least 50 mm², preferably 95 mm². This allows the contact unit to transfer particularly high currents.

At least two contact elements can protrude at different heights relative to a surface of the contact unit carrier, said surface facing the charging contact device. It is thus possible to ensure a defined sequence in the production of the contact pairs when at least two contact pairs are formed between one contact element and one charging contact each. When the contact unit carrier and the charging contact device are guided together, a sequence of contacts is inevitably maintained at all times and ensured by the geometric arrangement of the contact elements relative to the upper surface or surface of the contact unit carrier. Forming an unintentional or erroneous electric contact or a formation of contact pairs can easily be prevented in this way.

The charging contacts can be made of circuit boards made of metal and/or graphite. The circuit boards can in turn be disposed on a charging contact carrier of the charging contact device, the charging contact carrier being made of a dielectric material. The circuit boards can be made of copper, a copper alloy or stainless steel and be disposed so as to be spaced apart from each other on or recessed in the dielectric material. A surface of a lower surface of the circuit boards can be essentially flat and comparatively large relative to the contact elements, such that when the vehicle is being positioned relative to the contact device, any inaccuracies can be compensated and, at the same time, an incorrect electric contact is not formed. It can also be envisaged that the charging system enables a charging process of the vehicle irrespective of direction, i.e., irrespective of the side from which the vehicle is electrically connected with the contact device or driven over said contact device. When the contact device is essentially rectangular, the charging contact device or the charging contact carrier can also be rectangular, such that the contact device and the charging contact device with their respective longitudinal axes are disposed in the direction of the longitudinal extension of the vehicle during a charging process.

The charging system according to the invention comprises a charging contact device and a contact device having a contact unit according to the invention, the contact device or the charging contact device comprising a positioning device.

The charging system can comprise the contact device having the contact unit carrier and the charging contact device, said contact device being disposed on a vehicle roof of a vehicle, the positioning device having a pantograph or a rocker by means of either of which the contact unit carrier can be positioned in at least the vertical direction relative to the charging contact unit, such that an electrically conductive connection can be formed between the vehicle and a stationary charging station. In the case of a rocker, an additional linkage may be provided, which stabilizes the contact unit carrier relative to a charging contact device or aligns it in the respective direction. A pantograph or a rocker or a corresponding mechanical drive is particularly simple and cost-effective to produce. Additionally, the positioning device may also have a transverse guide by means of which the contact unit carrier can be positioned in the transverse direction relative to the charging contact device or to a direction of travel of the vehicle. The transverse guide can be disposed on a vehicle or on a pantograph or a rocker of the positioning device. In both cases, the positioning device or a contact unit carrier disposed on the positioning device can be displaced transverse to the direction of travel of the vehicle. This displaceability allows a wrong positioning of the vehicle at a bus stop transverse to the direction of travel to be compensated. Moreover, possible vehicle movements due to a one-sided lowering of the vehicle for people entering and exiting the vehicle can be compensated in such a manner that the contact unit carrier cannot become displaced in the transverse direction relative to the charging contact device. The contact device can be disposed on a vehicle roof, for example, allowing the contact unit carrier to be moved from the vehicle roof toward the charging contact device and back by means of the positioning device. Alternatively, the contact device can be disposed on the charging station, in which case the contact unit carrier can be moved from a support, such as a pole or a bridge, at a bus stop in the direction of a vehicle roof having a charging contact device and back.

Alternatively, the charging system can comprise the charging contact device, which is disposed on a vehicle floor of a vehicle, and the contact device having the contact unit carrier, the contact units being positionable relative to the charging contacts by means of the positioning device in such a manner that an electrically conductive connection is formable between the vehicle and a stationary charging station. In this case, the positioning device can also be realized by a level control of the vehicle by means of which the charging contact device is positionable in at least the vertical direction. A level control of a vehicle is well known and is used for adjusting a vehicle or a vehicle floor above a ground by lowering and raising it. A level control can be realized by means of a pneumatic chassis suspension of a vehicle, for instance. It is then also possible to lower the vehicle together with the charging contact device onto the contact device for a charging process by means of the level control. The contact device can also be disposed on a ground below the vehicle on which the vehicle can drive, owing to which structural measures on the ground, such as excavating a cavity, are no longer necessary. In this case, the contact device can be flexibly disposed on any accessible ground in a simple manner. Because of the simple assembly and disassembly of the contact device on the ground or rather its surface, it is in particular possible to temporarily dispose or set up the contact device at the stop as needed without great effort. The contact unit carrier can be attached to a base frame of the contact device or be inserted in it. Thus, the contact device can also be realized so advantageously that the vehicle can drive on and/or over it. The contact device can be square or rectangular so that it fits between pairs of vehicle's tires. Simultaneously, parts of the contact device or alternatively the whole contact device can be realized so that vehicles can drive over it in such a manner that the vehicle is standing on the contact device with its tires during a charging process. The dimensions of the contact device can also be adapted to the dimensions of the vehicle, for instance according to the size of a parking bay.

Alternatively, the charging system can comprise the contact device having the contact unit carrier and the charging contact device which is disposed on a vehicle roof of a vehicle, the positioning device having a pantograph or a rocker by means of either of which the charging contact device is positionable in at least the vertical direction relative to the contact unit carrier in such a manner that an electrically conductive connection is formable between the vehicle and a stationary charging station.

Alternatively, the charging system can comprise the contact device having the contact unit carrier and the charging contact device, which is disposed on a vehicle floor of a vehicle, the charging contacts being positionable relative to the contact units by means of the positioning device in such a manner that an electrically conductive connection is formable between the vehicle and a stationary charging station.

Further advantageous embodiments of a charging system are apparent from the dependent claims referring back to claim 1.

Generally, the invention can be used for any electric vehicle which is powered by, for example, batteries, accumulators, capacitators or supercapacitators, which all have to be recharged.

Hereinafter, preferred embodiments of the invention will be described in more detail with reference to the accompanying drawings.

In the figures:

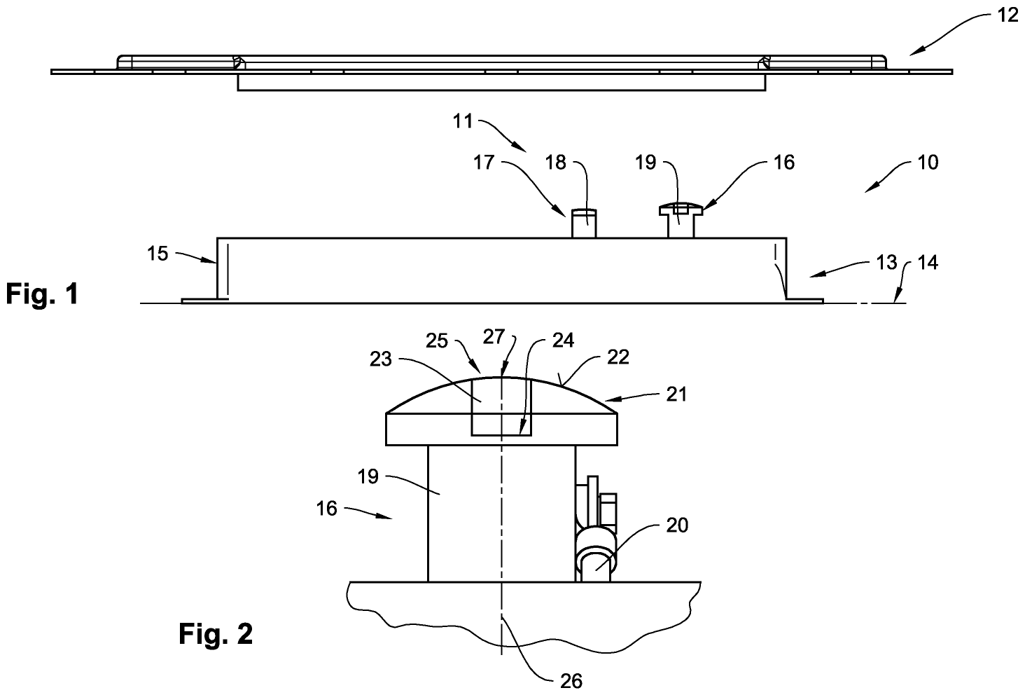

FIG. 1 shows a side view of a charging system;

FIG. 2 shows a detailed view of a contact element of the charging system;

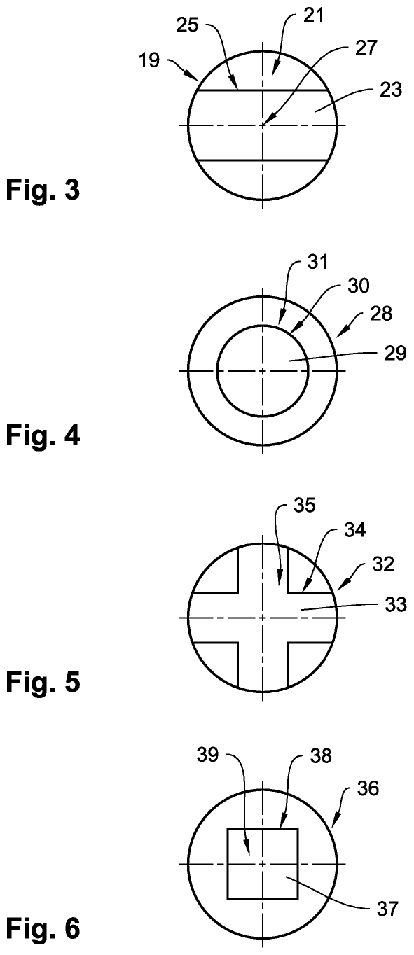

FIG. 3 shows a top view of the contact element of FIG. 2;

FIG. 4 shows a top view of a contact element in a second embodiment;

FIG. 5 shows a top view of a contact element in a third embodiment;

FIG. 6 shows a top view of a contact element in a fourth embodiment.

A combined view of FIGS. 1 to 3 shows a charging system 10 having a contact unit arrangement 11. Charging system 10 comprises a charging contact device 12 which is disposed on a vehicle floor of a vehicle (not shown) and which has charging contacts (not shown) which are made of circuit boards. Furthermore, charging system 10 comprises contact device 13 which is disposed on a ground 14 on which a vehicle can drive. Contact device 13 comprises a contact unit carrier 15, which is formed in the shape of a trough in this case, and a number of contact units 16 and 17 of contact unit arrangement 11. By means of a positioning device (not shown) of charging system 10, charging contact device 12 can be lowered onto contact device 13, such that contact pairs can be formed between conductor strips of charging contact device 12 and each assigned contact unit 16 and 17.

Contact unit 16 serves to transmit signals between charging contact device 12 and contact device 13, contact unit 17 serving to transfer a charging current. Contact device 13 thus has a plurality of contact units 17 (not shown). Contact unit 17 has a contact element 18 which is essentially made of copper or a copper alloy. Contact units 16 and 17 or the associated contact elements 18 or 19 are elastically or displaceably mounted on contact device 13. Contact unit 16 has a contact element 19 which is shown in more detail in FIGS. 2 and 3.

Contact element 19 is made of metal and a connecting lead 20 is directly attached to contact element 19. Contact element 19 is bolt-shaped and has a contact bump 21. Contact bump 21 forms a contact surface 22 for forming an electric contact with charging contacts or conductor strips (neither shown) of charging contact device 12. Contact element 19 is partially formed by a contact piece 23 made of carbon or graphite in the area of contact surface 22. Contact surface 22 is dome-shaped and contact piece 23 is inserted into a cavity 24 in contact bump 21 so as to be flush with contact surface 22. In this case, cavity 24 is a groove 25 into which contact piece 23 is glued by means of an electrically conductive bonding material. Groove 25 is formed in contact bump 21 in such a manner that contact piece 23 is disposed coaxially or symmetrically relative to a longitudinal axis 26 of bolt-shaped contact element 19. A central, highest point 27 of contact surface 22 is thus formed by contact piece 23. When contact element 19 approaches a charging contact of charging contact device 12, an electric contact is thus initially established via point 27.

FIG. 4 shows an embodiment of a contact element 28 which, in contrast to the contact element of FIG. 3, has a contact piece 29, which forms a circular contour 30 in a contact surface 31 of contact element 28.

FIG. 5 shows a contact element 32 having a contact piece 33 which forms an essentially cross-shaped contour 34 in a contact surface 35 of contact element 32.

FIG. 6 shows a contact element 36 having a contact piece 37 which essentially forms a square contour 38 in a contact surface 39 of contact elements 36.

1. A contact unit (16) for a charging system (10) for electrically driven vehicles, in particular passenger vehicles, trucks, busses or the like, the charging system comprising a charging contact device (12) and a contact device (13) having a contact unit carrier (15), the contact unit carrier having the contact unit, the contact unit being electrically connectable to a charging contact of the charging contact device to form a contact pair, the contact unit having a contact element (19, 28, 32, 36) made of metal, the contact unit having a connecting lead (20) for connection to the vehicle or the charging station, the contact element having a contact bump (21), the contact bump forming a contact surface (22, 31, 35, 39) for forming an electric contact with the charging contact, wherein the contact element is at least partially formed by a carbon contact piece (23, 29, 33, 37) in the area of the contact surface.

2. The contact unit according to claim 1, wherein the contact element (19, 28, 32, 36) is realized so as to be bolt-shaped or the contact surface (22, 31, 35, 39) is realized so as to be at least partly curved.

3. The contact unit according to claim 1, wherein the contact piece (23, 29, 33, 37) is realized so as to be flush with the contact surface (22, 31, 35, 39).

4. The contact unit according to claim 1, wherein characterized in that the contact piece (23, 29, 33, 37) is made of graphite or hard coal.

5. The contact unit according to claim 1, wherein the contact piece (23, 29, 33, 37) is coaxially disposed relative to a longitudinal axis (26) of the contact element (19, 28, 32, 36), the contact piece forming a point (27) of the contact surface (22, 31, 35, 39) closest to a charging contact.

6. The contact unit according to claim 1, wherein a first partial surface of the contact surface (22, 31, 35, 39) is formed by the contact piece (23, 29, 33, 37) and a second partial surface of the contact surface is formed by the contact bump (21), the first partial surface being circular, rectangular, square, star-shaped or cross-shaped.

7. The contact unit according to claim 1, wherein the contact piece (23, 29, 33, 37) is inserted into a cavity (24) which is formed in the contact bump (21).

8. The contact unit according to claim 7, wherein the contact piece (23, 29, 33, 37) is attached in the cavity (24) by means of an electrically conductive bonding material or a solder.

9. The contact unit according to claim 7, wherein the contact piece (23, 29, 33, 37) is formed in the cavity (24) by means of sintering.

10. The contact unit according to claim 1, wherein a spring of the contact unit (16) exerts a spring force on the contact element (19, 28, 32, 36) in such a manner that the contact element is pushed in the direction of a charging contact.

11. The contact unit according to claim 1, wherein the contact device has at least two additional contact units (17), the corresponding contact surface for forming an electric contact with the charging contact being completely made of metal.

12. The contact unit according to claim 11, wherein the contact unit (16) is realized such that a signal is transmissible via the contact element (19, 28, 32, 36), a current of 100 A to 1000 A, at a voltage of 60 V to 1500 V, being transferrable via the additional contact units.

13. The contact unit according to claim 1, wherein the connecting lead (20) is directly or indirectly attached to the contact element (19, 28, 32, 36).

14. The contact unit according to claim 1, wherein at least two contact elements (19, 28, 32, 36) protrude at different heights relative to a surface of the contact unit carrier (15), said surface facing the charging contact device.

15. The contact unit according to claim 1, wherein the charging contacts are formed by circuit boards of metal or graphite.

16. A charging system (10) having a charging contact device (12) and a contact device (13) having a contact unit (16) according to claim 1, the contact device or the charging contact device comprising a positioning device.

17. The charging system according to claim 16, wherein the charging system (10) comprises the contact device (13) having the contact unit carrier (15) and the charging contact device (12), said contact device (13) being disposed on a vehicle roof of a vehicle, the positioning device having a pantograph or a rocker by means of either of which the contact unit carrier is positionable in at least the vertical direction relative to the charging contact unit in such a manner that an electrically conductive connection is formable between the vehicle and a stationary charging station.

18. The charging system according to claim 16, wherein the charging system (10) comprises the charging contact device (12), which is disposed on a vehicle floor of a vehicle, and the contact device (13) having the contact unit carrier (15), the contact units (16) being positionable relative to the charging contacts by means of the positioning device in such a manner that an electrically conductive connection is formable between the vehicle and a stationary charging station.

19. The charging system according to claim 16, wherein the charging system (10) comprises the contact device (13) having the contact unit carrier (15) and the charging contact device (12), which is disposed on a vehicle roof of a vehicle, the positioning device having a pantograph or a rocker by means of either of which the charging contact device is positionable in at least the vertical direction relative to the contact unit carrier in such a manner that an electrically conductive connection is formable between the vehicle and a stationary charging station.

20. The charging system according to claim 16, wherein the charging system (10) comprises the contact device (13) having the contact unit carrier (15) and the charging contact device (12), which is disposed on a vehicle floor of a vehicle, the charging contacts being positionable relative to the contact units (16) by means of the positioning device in such a manner that an electrically conductive connection is formable between the vehicle and a stationary charging station.
